(19) United States
(12) Patent Application Publication
(10) Pub. No.: US 2011/0134660 A1
(43) Pub. Date: Jun. 9, 2011

(54) Backlight Module Structure

(75) Inventors: Ya-Wei Deng, Hsin-Chu (TW); Po-Iem Lin, Hsin-Chu (TW); Ya-Han Ko, Hsin-Chu (TW)

(73) Assignee: AU OPTRONICS CORPORATION, Hsin-Chu (TW)

(21) Appl. No.: 12/952,377

(22) Filed: Nov. 23, 2010

(30) Foreign Application Priority Data
Dec. 4, 2009 (TW) 098141621

(51) Int. Cl. F21V 7/22

(52) U.S. Cl. 362/612

(57) ABSTRACT

A backlight module structure including a light guide plate and a plurality of light emitting diodes is provided. A plurality of first micro-structures and a plurality of second micro-structures are formed on the light incident surface of the light guide plate, and the first micro-structure and the second micro-structure are respectively disposed on two sides of the light incident surface and distributed along the light incident surface. The first micro-structure has a first receiving surface and the second micro-structure has a second receiving surface. The first and second receiving surfaces are faced oppositely and incline at least one inclined angle, such that the normal lines thereof are deflected to the imaginational center of the light guide plate, respectively. The light emitting diode has an emitting surface disposed correspondingly to the abovementioned the first receiving surface or the second receiving surface, and the lights of light emitting diodes enter into the light guide plate from the first receiving surfaces and the second receiving surfaces.

### BACKGROUND OF THE INVENTION

1. Field of the Invention

The present invention relates to a backlight module structure, and more particularly, to an edge type light-emitting diode (LED) backlight module structure capable of enhancing the incident light efficiency.

2. Description of the Prior Art

Under the global trend of developing small-size and energy-saving display, it is an indisputable fact that the LED is used as the backlight source to replace the conventional cold cathode fluorescent (CCFL). LEDs have environmental advantages of no mercury, and the housing can be designed thinner and the lighting efficiency can be also enhanced compared to the cold cathode tube. Therefore, the LED backlight source is used in most notebooks. Many technical leaders in LED applications have adopted the LED backlight source for more than 90 percent of NB products.

As shown in FIG. 1, a conventional edge type backlight module structure includes a light guide plate 10 and a LED bar with a plurality of LEDs 22 distributed on a circuit board 20. Lighting surfaces 24 of the LEDs 22 are disposed on a light incident surface 12 of the light guide plate 10 to provide light sources to the light guide plate 10. Since the conventional LED is disposed parallel to the light incident surface 12, the light of the LED 22 is vertically emitted into the light guide plate 10 from the light incident surface 12. As shown in FIG. 2, the computer program simulation result shows that the light leakage on two sides of the light guide plate 10 is very obvious (the lights outside the box). In other words, most lights emitted from the LEDs 22 on the two sides of the light guide plate 10 are wasted, so that the lighting efficiency of the conventional edge type backlight module structure cannot be enhanced.

However, no matter the LEDs 22 are disposed on one side of the light guide plate 10 as this embodiment, or the LEDs 22 are disposed parallel to the light incident surface 12 on two sides, three sides, or four sides of the light guide plate 10, the above-mentioned problems will occur. Therefore, a novel backlight module structure is disclosed in the invention to overcome the above-mentioned problems in prior arts.

### SUMMARY OF THE INVENTION

A main scope of the invention is to provide a backlight module structure to make the LEDs disposed near the edges on two sides of the light guide plate have better incident light efficiency.

Another scope of the invention is to provide a backlight module structure capable of effectively solving the local dimming problem.

Another scope of the invention is to provide a backlight module structure capable of increasing module central brightness.

Another scope of the invention is to provide a backlight module structure capable of reducing light leakage.

Another scope of the invention is to provide a backlight module structure capable of effectively focusing the lights into the same region.

The invention provides a backlight module structure including a light guide plate and a plurality of light emitting diodes. The light guide plate has a light incident surface and an imaginational center. A plurality of first micro-structures and a plurality of second micro-structures are formed on the light incident surface, each of the first micro-structures and each of the second micro-structures are disposed on two sides of the light incident surface respectively and distributed along the light incident surface, wherein each of the first micro-structures has a first receiving surface and each of the second micro-structures has a second receiving surface. The first receiving surfaces and the second receiving surfaces are faced oppositely to incline at least one inclined angle, such that normal lines thereof are deflected to the imaginational center, respectively. Each of the light emitting diodes has an emitting surface disposed correspondingly to the first receiving surface or the second receiving surface, and lights emitted from the emitting surfaces of the light emitting diodes enter into the light guide plate from the first receiving surfaces and the second receiving surfaces, respectively.

In a preferred embodiment, each of the emitting surfaces of the light emitting diodes is disposed attached to the first receiving surface or the second receiving surface. Each first micro-structure and each second micro-structure form a sawtooth structure and a plurality of concave spaces in the sawtooth structure, wherein the LEDs are disposed in the plurality of concave spaces of the sawtooth structure. Compared with the first micro-structure farther away from the imaginational center, the receiving surface of the first micro-structure disposed closer to the imaginational center has a smaller inclined angle. In other words, the inclined angle of the LED disposed on two sides of the light guide plate is larger than that of the LED disposed on the center of the light guide plate. The above-mentioned inclined angle ranges from 5° to 80°, and it can be changed based on the size or design of the light guide plate. The light incident surface further includes a flat incident area parallel to the extending direction of the light incident surface and between the first micro-structures and the second micro-structures, and at least one light emitting diode is disposed corresponding to the flat incident area.

The invention also provides a backlight module structure including a light guide plate having a plurality of unit blocks. In other words, two ends of the light incident surface of each unit block form a plurality of first micro-structures and a plurality of second micro-structures, wherein the second micro-structure and the first micro-structure of the adjacent unit block will be arranged in a line. In addition, in another preferred embodiment, each light guide plate can be also arranged and combined to be a larger-size light guide plate, wherein each second micro-structure and each first micro-structure of the adjacent light guide plate are arranged in a line, and then a single LED module is disposed on a side of the light incident surface of the light guide plate. In this embodiment, it is better to dispose a LED between the light guide plates, namely between the second micro-structure of each light guide plate and the first micro-structure of the adjacent light guide plate to reduce the local dimming phenomenon.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a schematic diagram of a conventional backlight module structure.

FIG. 2 illustrates a lighting schematic diagram of optically simulating the conventional backlight module structure.

FIG. 3A illustrates an exploded diagram of a backlight module structure of the invention.

FIG. 3B illustrates an assembly diagram of a backlight module structure in the invention.

FIG. 4A illustrates a partial schematic diagram of the first micro-structure of the backlight module structure in the invention.

FIG. 4B illustrates a partial schematic diagram of the second micro-structure of the backlight module structure in the invention.

FIG. 4C illustrates a schematic diagram of the LED module disposed on the light guide plate in the invention.

FIG. 5A illustrates a schematic diagram of an embodiment of the first receiving surface and the second receiving surface opposite to each other including a variable inclined angle.

FIG. 5B illustrates a schematic diagram of another embodiment of the first receiving surface and the second receiving surface opposite to each other including a variable inclined angle.

FIG. 6 illustrates a schematic diagram of another embodiment of the backlight module structure of the invention.

FIG. 7 illustrates a schematic diagram of another embodiment of the backlight module structure of the invention.

FIG. 8 illustrates a lighting schematic diagram of optically simulating the backlight module structure of the invention.

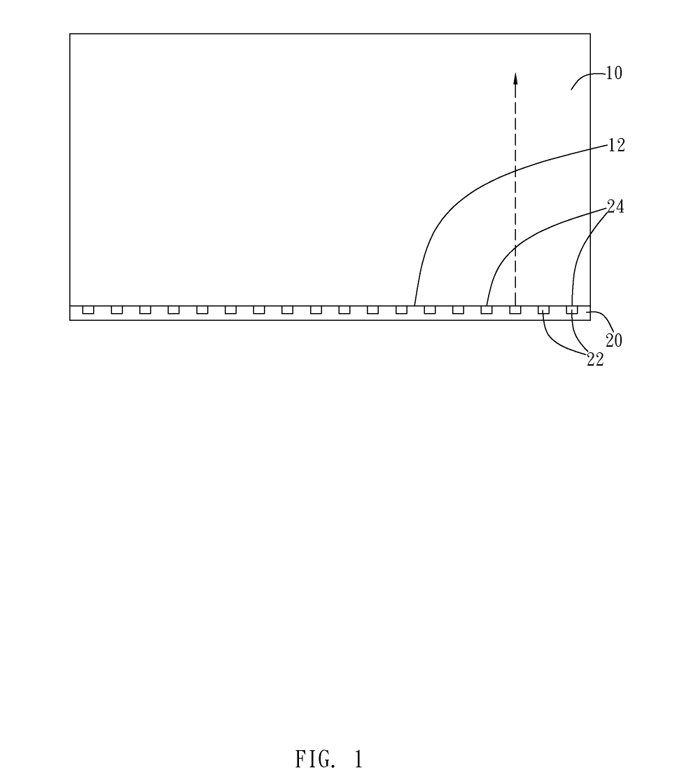

### DETAILED DESCRIPTION OF THE INVENTION

The invention provides a backlight module structure capable of increasing central brightness and reducing light leakage. The invention also includes an electronic device using the backlight module structure. In a preferred embodiment, the electronic device provided by the invention is a notebook. However, in other embodiments, the electronic device can be flat display monitor/television, mobile communication device, or other electronic devices having the backlight module structure. In addition, as to the backlight module structure of the invention, it is better to provide backlight by edge lighting, and the LED light bar is used as the backlight source. However, in other embodiments, a plurality of single LEDs can be distributed on the light incident surface of the light guide plate. The embodiments and operation methods of the invention will be further introduced with the figures as follows.

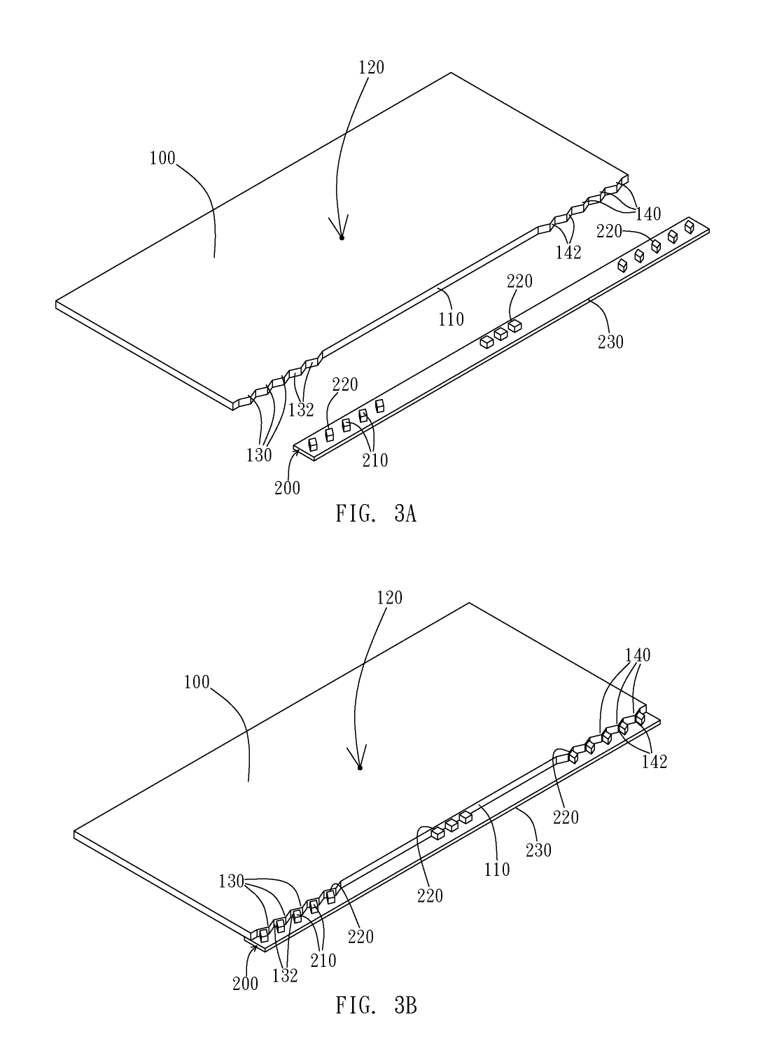

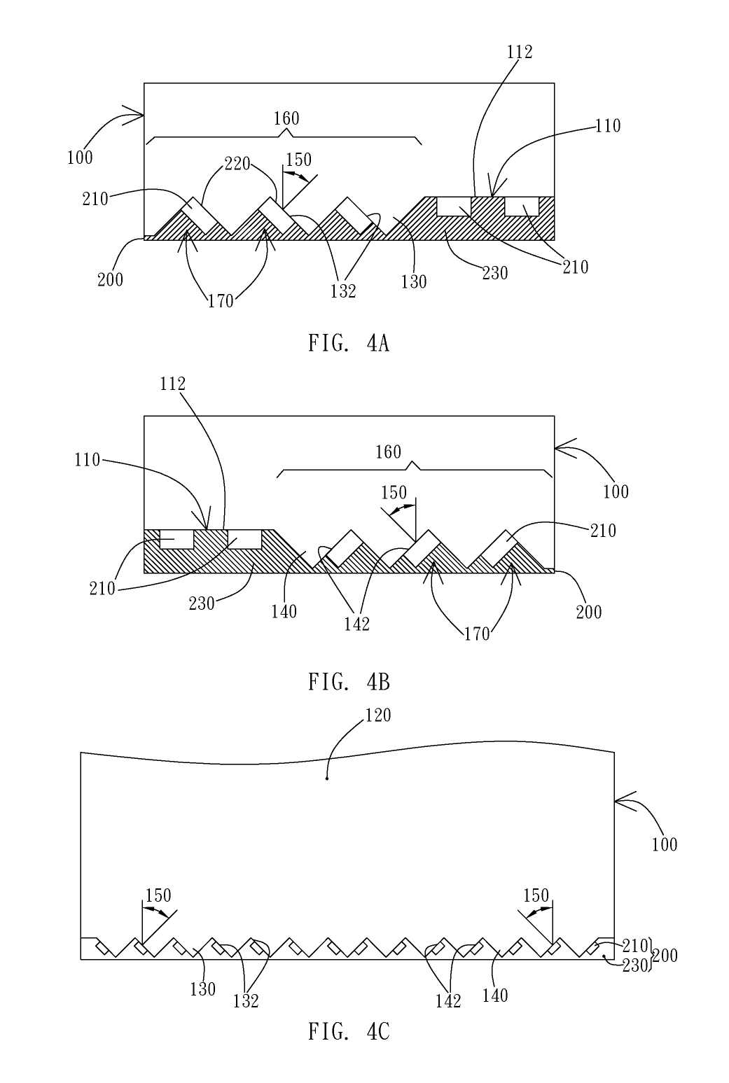

As shown in FIG. 3A and FIG. 3B, the invention provides a backlight module structure including a light guide plate 100 and a plurality of LEDs 210. The light guide plate 100 has a light incident surface 110 and an imaginational center 120. A plurality of first micro-structures 130 and a plurality of second micro-structures 140 are formed on the light incident surface 110. The first micro-structures 130 and the second micro-structures 140 are disposed on two sides of the light incident surface 110 and distributed from edges toward the center of the light incident surface 110 along the light incident surface 110, respectively. It is better that the above-mentioned imaginational center 120 is the geometrical center of the light guide plate 100, but it can be also the center of mass or other positions near the center inside the light guide plate. Each of the first micro-structures 130 has a first receiving surface 132 and each of the second micro-structures 140 has a second receiving surface 142. The first receiving surfaces 132 and the second receiving surfaces 142 are faced oppositely and incline at least one inclined angle 150 (as shown in FIG. 4A and FIG. 4B), such that normal lines thereof are deflected to the imaginational center 120, respectively. As shown in FIG. 4C, the normal line of the first receiving surface 132 and the normal line of the second receiving surface 142 are preferably deflected to the imaginational center 120 of the light guide plate 100, respectively.

In this embodiment, the LEDs 210 are preferably included in a LED module 200. Each LED 210 is electrically connected to the circuit board 230 to form the LED module 200. Then, the LED module 200 is disposed on the side of the light incident surface 110 of the light guide plate 100, so that the emitting surface 220 of each LED 210 faces toward the first receiving surface 132 or the second receiving surface 142. After the LED module 200 is electrically conducted, the lights emitted from the emitting surfaces 220 of LEDs 210 enter into the light guide plate 100 from the first receiving surface 132 and the second receiving surface 142. As shown in FIG. 3B, because the first receiving surface 132 and the second receiving surface 142 are inclined with respect to the imaginational center 120, the lights of each LED 210 will be focused toward the imaginational center 120 to increase the central brightness of the light guide plate 100 and reduce the light leakage on the two sides of the light guide plate 100.

Please refer to the embodiment shown in FIG. 4A and FIG. 4B at the same time, each of the emitting surfaces 220 of the LEDs 210 is preferably disposed attached to the first receiving surface 132 or the second receiving surface 142. However, in other embodiments, a gap of specific angle or unspecific angle between the emitting surface 220 of each LED 210 and each first receiving surface 132 or between the emitting surface 220 of each LED 210 and each second receiving surface 142 can be changed based on practical needs. As shown in FIG. 4A, the first micro-structures 130 of the light guide plate 100 form a sawtooth structure 160 and a plurality of concave spaces 170 in the sawtooth structure 160, and the LEDs 210 are disposed in the plurality of concave spaces 170 in the sawtooth structure 160, respectively. Similarly, as shown in FIG. 4B, the second micro-structures 140 also form the sawtooth structure 160 and the plurality of concave spaces 170 in the sawtooth structure 160, and the LEDs 210 are disposed in the plurality of concave spaces 170 in the sawtooth structure 160, respectively. In this embodiment, it is better that the two sides of each concave space 170 are the inverted V-shaped structure with equal lengths. However, in other embodiments, the two sides of each concave space 170 can have different lengths or other special geometry such as U-shaped or W-shaped structures.

In addition, as shown in FIG. 4A and FIG. 4B, the light incident surface 110 of the light guide plate 100 further includes a flat incident area 112 parallel to the extending direction of the light incident surface 110 and between the first micro-structure 130 and the second micro-structure 140, wherein at least one LED 210 is disposed corresponding to the flat incident area 112. Since the flat incident area 112 is closer to the center 120 of the light guide plate 100 than the sawtooth structure 160 on two sides, the light of the LED 210 can be roughly emitted in a direction toward the imaginational center 120 (as shown in FIG. 3B) and the deviation will be small. However, in the embodiment shown in FIG. 4C, the flat incident area 112 can be changed to the sawtooth structure 160. In general, the embodiment is preferably applied to large-size light guide plate 100. Furthermore, in the embodiments shown in FIG. 4A˜FIG. 4C, it is better that the inclined angle 150 of each first receiving surface 132 is similar to the inclined angle 150 of each second receiving surface 142. The definition of above-mentioned inclined angle 150 is an angle ranging from the normal line of the first receiving surface 132 or the second receiving surface 142 to the vertical line perpendicular to the light incident surface 110 (parallel to a horizontal surface). Therefore, the receiving surface is used as the base surface to calculate each inclined angle 150, and the inclined angle 150 will be accordingly changed with different receiving surface.

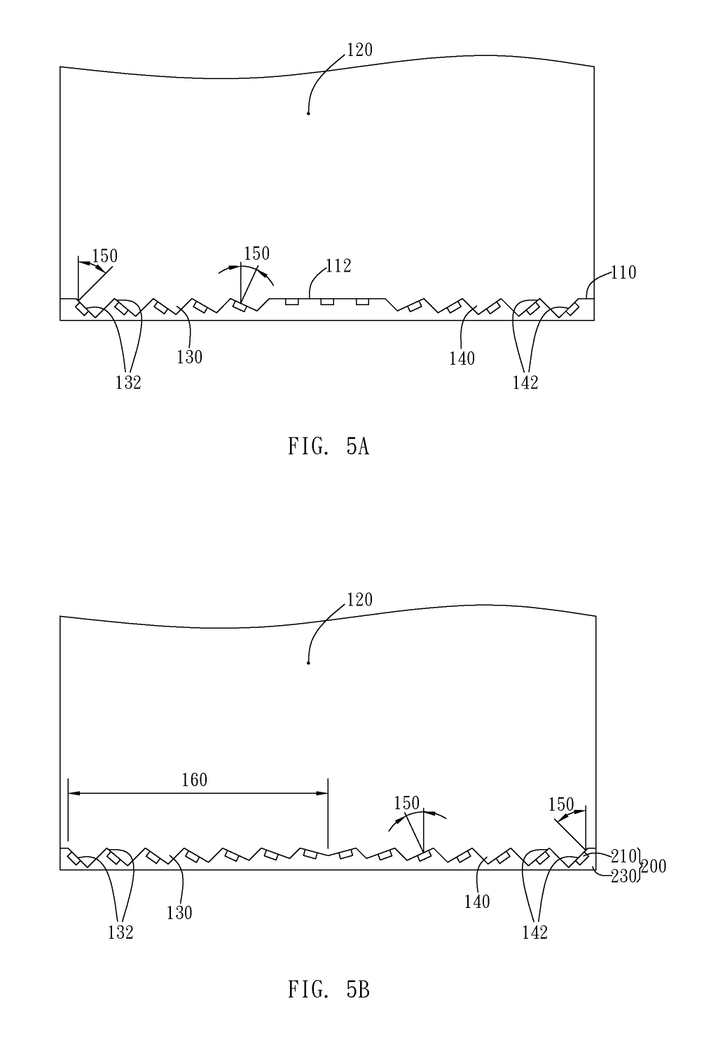

However, in the embodiment shown in FIG. 5A and FIG. 5B, with different sizes of the backlight module structure, the inclined angles 150 of each first receiving surface 132 or each second receiving surface 142 can be set different. Compared with the first micro-structure 130 farther away from the imaginational center 120, the first receiving surface 132 of the first micro-structure 130 disposed closer to the imaginational center 120 has a smaller inclined angle 150. In short, the inclined angle 150 of the first receiving surface 132 closer to the edge of the light guide plate 100 is larger than that of the first receiving surface 132 farther away from the edge of the light guide plate 100, so that each first receiving surface 132 or each second receiving surface 142 will be deflected to the imaginational center 120. According to different sizes of the backlight module structure (different sizes of the light guide plate), the variable range of the inclined angle 150 is also different, usually ranging from 5° to 80°. In addition, based on different sizes of light guide plate 100 or other needs, a flat incident area 112 can be disposed around the center of the light incident surface 110, as shown in FIG. 5A. However, in the embodiment shown in FIG. 5B, the sawtooth structure 160 having geometry can be used to replace the flat incident area.

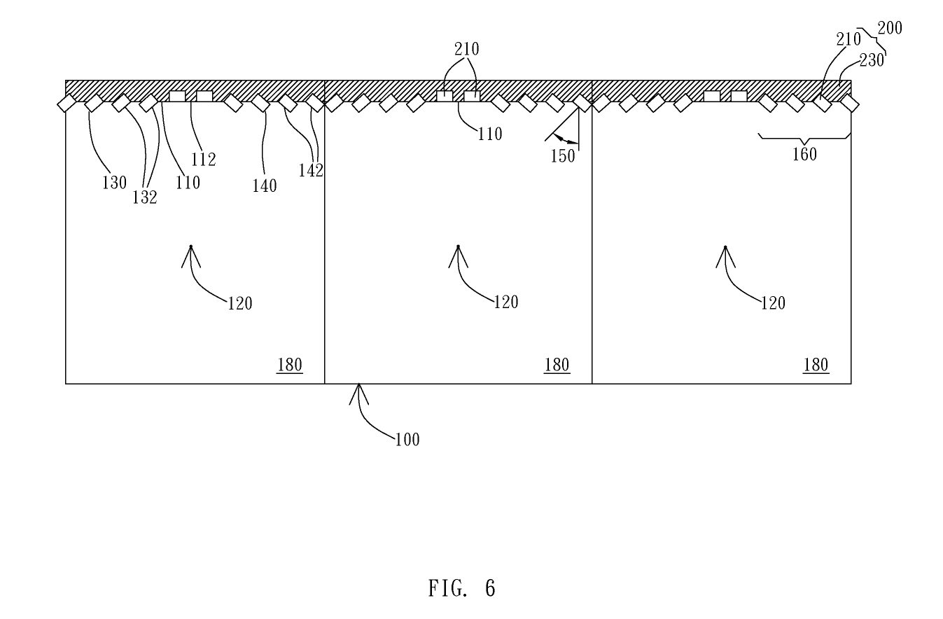

As shown in FIG. 6, the invention further provides a backlight module structure including a light guide plate 100 having a plurality of unit blocks 180. In fact, the light guide plate 100 in this embodiment is a large-size light guide plate 100, and it is preferred that this light guide plate 100 has unit blocks 180 with the same sizes or different sizes. In different embodiments, the light guide plate 100 can be divided into a plurality of small light guide plates of the same size or different size based on the unit blocks 180 of different sizes. In this embodiment, a plurality of first micro-structures 130 and a plurality of second micro-structures 140 are formed on both sides of the light incident surface 110 of each unit block 180, and the second micro-structures 140 and the first micro-structures of the adjacent unit block 180 are arranged in a line. In other words, as a single light guide plate 100, each unit block 180 has the plurality of first micro-structures 130 with the first receiving surfaces 132 and the plurality of second micro-structures 140 with the second receiving surfaces 142, wherein the first receiving surfaces 132 and the second receiving surfaces 142 are faced oppositely and incline at least one inclined angle 150, such that normal lines thereof are deflected to the imaginational center 120, respectively.

In the embodiment shown in FIG. 6, the light guide plate 100 can be divided into a plurality of small light guide plates of the same size or different size based on the unit blocks 180 of different sizes and also cooperated with the disposition of the corresponding LEDs 210 or LED modules 200. As shown in FIG. 6, the outmost second receiving surface 142 on each unit block 180 and the closest first receiving surface 132 on the adjacent unit block 180 are oppositely inclined to each other. The LED 210 relatively disposed on the first receiving surface 132 of the unit block 180 and the LED 210 relatively disposed on the second receiving surface 142 of the adjacent unit block 180 are also oppositely inclined to each other. In addition, in this embodiment, it is preferred that the LEDs 210 are included in a single LED module 200 correspondingly disposed on a side surface of the light guide plate 100 having a plurality of unit blocks 180. However, in other embodiments, the LED module 200 with suitable length can be disposed based on the unit blocks 180. As to other backlight module structures in this embodiment, please refer to the above-mentioned embodiments, and they are not mentioned again here.

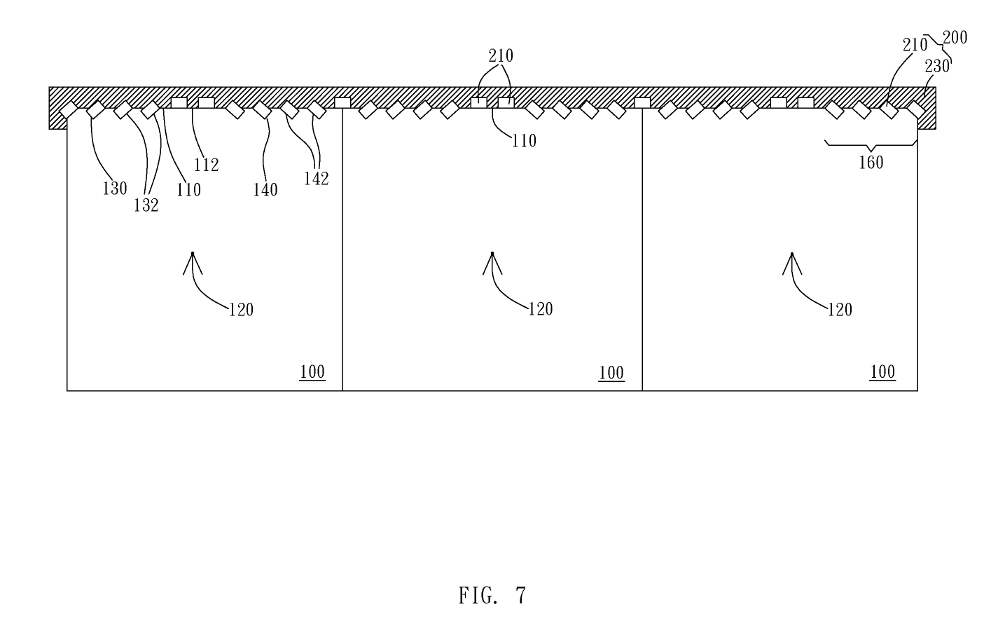

As shown in FIG. 7, the invention further provides a backlight module structure including a large-size light guide plate formed by combining a plurality of small-size light guide plates 100 and cooperated with a LED module 200. In this embodiment, each light guide plate 100 has a light incident surface 110, a plurality of first micro-structures 130, a plurality of second micro-structures 140, and an imaginational center 120. The first micro-structures 130 and the second micro-structures 140 are disposed on two sides of the light incident surface 110, and each second micro-structure 140 and each first micro-structure 130 of the adjacent light guide plate 100 are arranged in a line. In the embodiment shown in FIG. 7, LEDs 210 can be further disposed between every two light guide plates 100, namely between the outmost second micro-structure 140 of each light guide plate 100 and the first micro-structure 130 of the adjacent light guide plate 100, to improve the local dimming phenomenon between two light guide plates 100. As to other backlight module structures in this embodiment, please refer to the above-mentioned embodiments, and they are not mentioned again here.

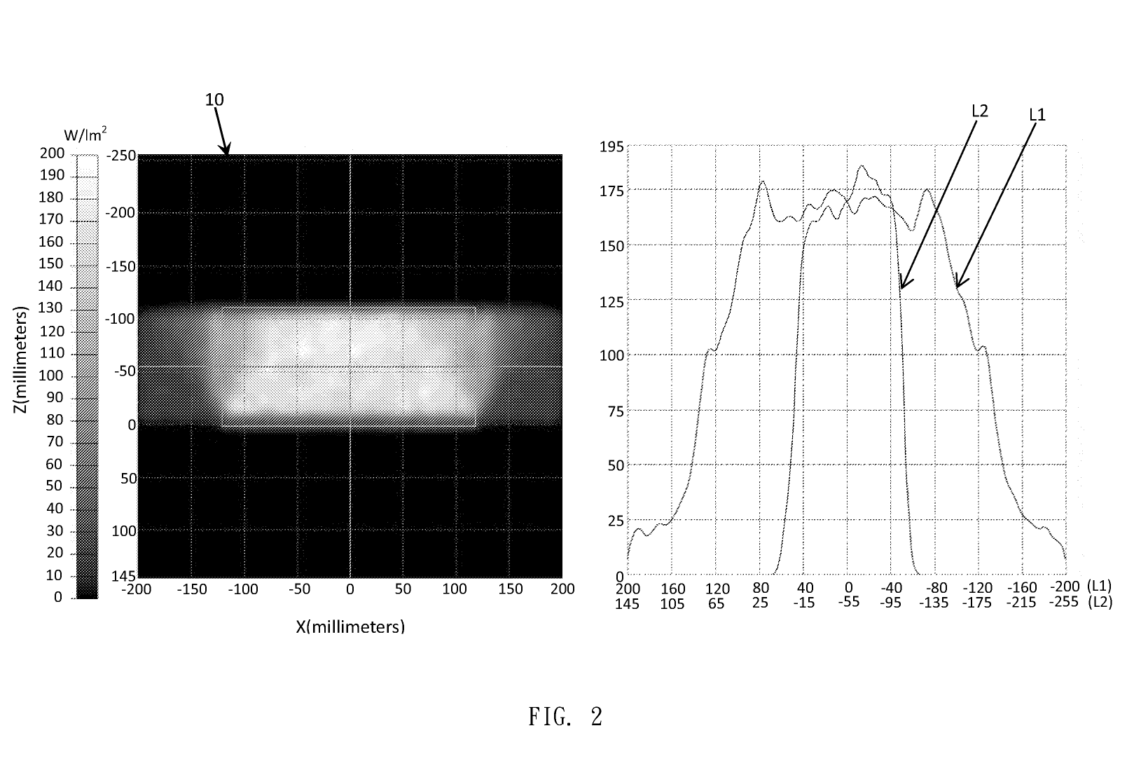

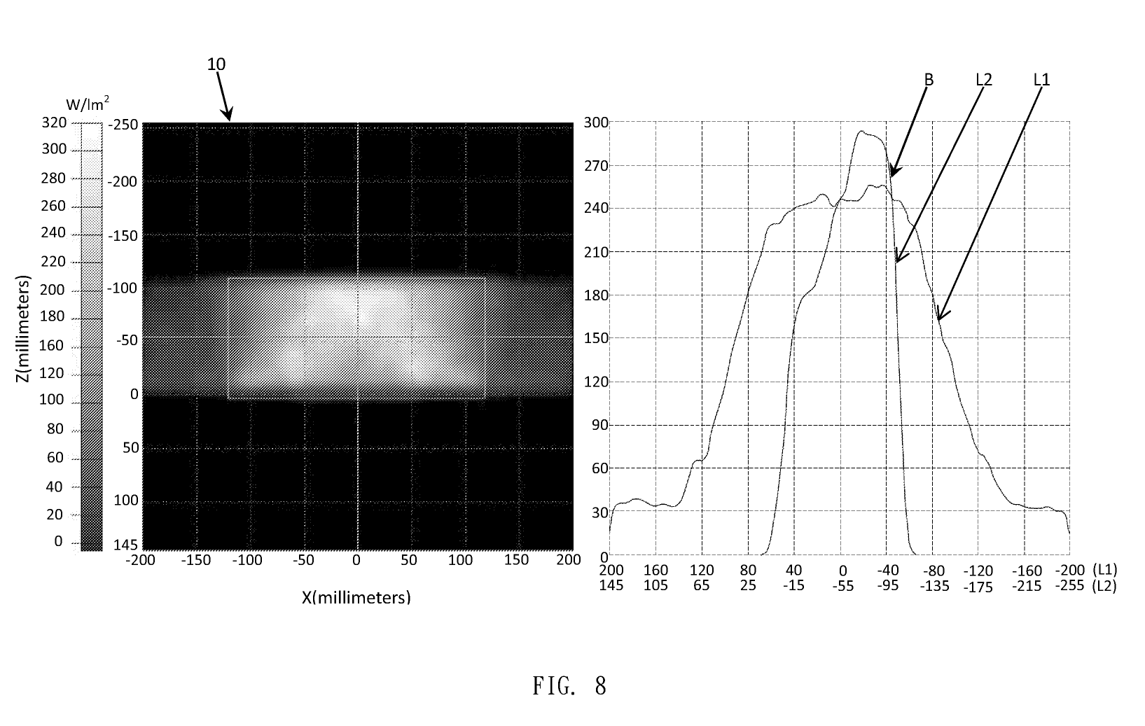

FIG. 8 shows a lighting test diagram of 20 LEDs. As shown in FIG. 8, it can be found based on the computer program simulation result that the central brightness value B will be increased at least 1.4 times compared to the prior art (as shown in FIG. 2), and the light leakage of the LED 210 on the light guide plate 100 will be also reduced. Above all, the central brightness of the backlight module structure can be enhanced and the light leakage on two sides can be improved by cooperating LEDs oppositely inclined to each other on two sides with the angles of each first micro-structure and second micro-structure corresponding to the light guide plate.

Although the present invention has been illustrated and described with reference to the preferred embodiment thereof, it should be understood that it is in no way limited to the details of such embodiment but is capable of numerous modifications within the scope of the appended claims.

What is claimed is:

1. A backlight module structure, comprising;
a light guide plate having a light incident surface, an imaginational center, a plurality of first micro-structures and a plurality of second micro-structures, the first micro-structure and the second micro-structure being disposed on two sides of the light incident surface respectively and distributed along the light incident surface, wherein each of the first micro-structures has a first receiving surface and each of the second micro-structures has a second receiving surface, and the first receiving surfaces and the second receiving surfaces are faced oppositely and incline at least one inclined angle, such that normal lines thereof are deflected to the imaginational center, respectively; and
a plurality of light emitting diodes, each of the plurality of light emitting diodes having an emitting surface, disposed correspondingly to the first receiving surface or the second receiving surface, and lights emitted from the emitting surfaces of the light emitting diodes entering into the light guide plate from the first receiving surfaces and the second receiving surfaces.

2. The backlight module structure of claim 1, wherein the emitting surfaces of the light emitting diodes are disposed attached to the first receiving surface and the second receiving surface, respectively.

3. The backlight module structure of claim 1, wherein compared with the first micro-structure farther away from the imaginational center, the receiving surface of the first micro-structure disposed closer to the imaginational center has a smaller inclined angle.

4. The backlight module structure of claim 1, wherein the inclined angle ranges from 5° to 80°.

5. The backlight module structure of claim 1, wherein the light incident surface comprises a flat incident area parallel to the extending direction of the light incident surface and between the first micro-structure and the second micro-structure, and at least one light emitting diode is disposed corresponding to the flat incident area.

6. The backlight module structure of claim 1, wherein a flat incident area is formed between adjacent first micro-structures and parallel to the extending direction of the light incident surface, and at least one light emitting diode is disposed corresponding to the flat incident area.

7. A backlight module structure, comprising;
a light guide plate having a plurality of unit blocks, each of the plurality of unit blocks having a light incident surface, an imaginational center, a plurality of first micro-structures and a plurality of second micro-structures disposed on two sides of the light incident surface of the unit block, wherein each of the plurality of first micro-structures has a first receiving surface and each of the plurality of the second micro-structures has a second receiving surface, the first receiving surfaces and the second receiving surfaces in each of the plurality of unit blocks are faced oppositely and incline at least one inclined angle, such that normal lines thereof are deflected to the imaginational center respectively, wherein the outmost second receiving surface on each unit block and the closest first receiving surface of adjacent unit block are oppositely inclined; and
a plurality of light emitting diodes, each of the plurality of light emitting diodes having an emitting surface, disposed corresponding to the first receiving surface or the second receiving surface, and lights emitted from the emitting surfaces of the light emitting diodes entering into the light guide plate from the first receiving surfaces and the second receiving surfaces.

8. The backlight module structure of claim 7, wherein the emitting surfaces of the light emitting diodes are disposed attached to the first receiving surface and the second receiving surface, respectively.

9. The backlight module structure of claim 7, wherein compared with the first micro-structure farther away from the imaginational center, the receiving surface of the first micro-structure disposed closer to the imaginational center has a smaller inclined angle.

10. The backlight module structure of claim 7, wherein the inclined angle ranges from 5° to 80°.

11. The backlight module structure of claim 7, wherein the light incident surface of each unit block comprises a flat incident area parallel to the extending direction of the light incident surface and between the first micro-structure and the second micro-structure, and at least one light emitting diode is disposed corresponding to the flat incident area.

12. The backlight module structure of claim 7, wherein a flat incident area is formed between the outmost second micro-structure of each unit block and the closest first micro-structure of adjacent unit block and parallel to the extending direction of the light incident surface, and at least one light emitting diode is disposed corresponding to the flat incident area.

13. A backlight module structure, comprising:
a plurality of light guide plates, each of the plurality of light guide plates having a light incident surface, an imaginational center, a plurality of first micro-structures, and a plurality of second micro-structures, each of the light incident surfaces being collinear, each of the plurality of first micro-structures and each of the plurality of second micro-structures being disposed on two sides of the light incident surface respectively and distributed along the light incident surface, wherein each of the first micro-structures has a first receiving surface and each of the second micro-structures has a second receiving surface, and the first receiving surfaces and the second receiving surfaces are faced oppositely and incline at least one inclined angle, such that normal lines thereof are deflected to the imaginational center respectively, wherein each of the second receiving surfaces of the plurality of light guide plates and the nearest first receiving surface of adjacent light guide plate are oppositely inclined; and
a plurality of light emitting diodes, each of the plurality of light emitting diodes having an emitting surface, disposed correspondingly to the first receiving surface or the second receiving surface, and lights emitted from the emitting surfaces of the light emitting diodes entering into the light guide plate from the first receiving surfaces and the second receiving surfaces.

14. The backlight module structure of claim 13, wherein each of the emitting surfaces of the light emitting diodes is disposed attached to the first receiving surface or the second receiving surface.

15. The backlight module structure of claim 13, wherein compared with the first micro-structure farther away from the imaginational center, the receiving surface of the first micro-structure disposed closer to the imaginational center has a smaller inclined angle.

16. The backlight module structure of claim 13, wherein the inclined angle ranges from 5° to 80°.

17. The backlight module structure of claim 13, wherein the light incident surface comprises a flat incident area parallel to the extending direction of the light incident surface and between the first micro-structures and the second micro-structures, and at least one light emitting diode is disposed corresponding to the flat incident area.

18. The backlight module structure of claim 13, wherein a flat incident area is formed between the outmost second micro-structure of each light guide plate and the closest first micro-structure of adjacent light guide plate and parallel to the extending direction of the light incident surface, and at least one light emitting diode is disposed corresponding to the flat incident area.
